(19) United States
(12) Patent Application Publication
(10) Pub. No.: US 2024/0387992 A1
(43) Pub. Date: Nov. 21, 2024

(54) REFLECTOR ANTENNA DEVICE

(71) Applicant: Mitsubishi Electric Corporation, Tokyo (JP)

(72) Inventors: Shigeru MAKINO, Nonoichi-shi (JP); Hiromasa NAKAJIMA, Tokyo (JP); Shinichi YAMAMOTO, Tokyo (JP); Yasuhiro NISHIOKA, Tokyo (JP)

(73) Assignee: Mitsubishi Electric Corporation, Tokyo (JP)

(21) Appl. No.: 18/788,913

(22) Filed: Jul. 30, 2024

Related U.S. Application Data
(63) Continuation of application No. PCT/JP2022/006562, filed on Feb. 18, 2022.

(51) Int. Cl. H01Q 3/46; H01Q 5/45

(52) U.S. Cl. CPC H01Q 3/46; H01Q 5/45

(57) ABSTRACT

There are provided a primary radiator that adjusts a position of a phase center of a radio wave to be radiated, forward or backward along a radial axis of the radio wave depending on a frequency of the radio wave to be radiated, and radiates a radio wave, a reflector that includes a dielectric plate of a flat plate shape, and a plurality of resonance elements that are aligned on a top surface of the dielectric plate that is a reflection surface for reflecting the radio wave, and that each adjust a phase of a reflected wave of the incident radio wave, and receives incidence of the radio wave radiated from the primary radiator and reflect the incident radio wave.

### CROSS REFERENCE TO RELATED APPLICATION

This application is a Continuation of PCT International Application No. PCT/JP2022/006562, filed on Feb. 18, 2022, which is hereby expressly incorporated by reference into the present application.

### TECHNICAL FIELD

The present disclosure relates to a reflector antenna device that includes a primary radiator and a reflector of a flat plate shape.

### BACKGROUND ART

In recent years, a reflect array of a simple structure that uses a reflector plate of a flat shape and has been developed as an antenna for wireless communication and a radar.

For example, Patent Literature 1 describes a reflect array antenna that optimizes an arrangement interval between resonance elements aligned on the top surface of a reflector plate of a flat plate shape and prevents occurrence of a grating lobe.

Furthermore, Patent Literature 2 describes a reflect array antenna that can provide a wider band by determining positions of a reflector plate and a primary radiator.

### CITATION LIST

### Patent Literatures

Patent Literature 1: JP 2016-92633 A

Patent Literature 2: JP 2017-79460 A

### SUMMARY OF INVENTION

### Technical Problem

However, Patent Literature 1 and Patent Literature 2 have made proposals for providing wider bands, yet cause a gain decrease due to a residual aberration that occurs at other than a set frequency, and still have narrow band characteristics compared to a parabola antenna with a primary radiator that is a horn antenna and a reflector plate of a paraboloid shape facing each other, and it is desired to provide a much wider band.

The present disclosure has been made in light of the above point, and an object of the present disclosure is to obtain a reflector antenna device that provides a wide frequency band and high aperture efficiency.

### Solution to Problem

A reflector antenna device according to the present disclosure includes: a primary radiator to adjust a position of a phase center of a radio wave to be radiated, forward or backward along a radial axis of the radio wave depending on a frequency of the radio wave to be radiated, and radiate the radio wave; and a reflector to receive the radio wave radiated from a phase center of the radio wave of a set frequency of the primary radiator and reflect the radio wave by converting a spherical wave of the radio wave into a planar wave on an aperture of the reflector, the reflector including a dielectric plate of a flat plate shape and a plurality of resonance elements that are aligned on a top surface of the dielectric plate that is a reflection surface for reflecting the radio wave, and that each adjust a phase of a reflected wave of the radio wave.

### Advantageous effects of Invention

According to the present disclosure, the position of the phase center of a radio wave radiated by a primary radiator is adjusted forward or backward along a radial axis of the radio wave depending on the frequency of the radio wave to be radiated, so that it is possible to provide a wide frequency band and high aperture efficiency even for frequencies other than a set frequency.

### BRIEF DESCRIPTION OF DRAWINGS

FIG. 1 is a configuration diagram illustrating a reflector antenna device according to Embodiment 1 seen from a side.

FIG. 2 is a front view illustrating a reflector of the reflector antenna device according to Embodiment 1.

FIG. 3 is a plan view illustrating an example of a resonance element of the reflector antenna device according to Embodiment 1.

FIG. 4 is a plan view illustrating another example of the resonance element of the reflector antenna device according to Embodiment 1.

FIG. 5 is a plan view illustrating another example of the resonance element of the reflector antenna device according to Embodiment 1.

FIG. 6 is a plan view illustrating another example of the resonance element of the reflector antenna device according to Embodiment 1.

FIG. 7 is a plan view illustrating another example of the resonance element of the reflector antenna device according to Embodiment 1.

FIG. 8 is a plan view illustrating another example of the resonance element of the reflector antenna device according to Embodiment 1.

FIG. 9 is a side view illustrating another example of the reflector of the reflector antenna device according to Embodiment 1.

FIG. 10 is a view for describing an arrangement relationship between a primary radiator and the reflector of the reflector antenna device according to Embodiment 1.

FIG. 11 is a view for describing a wavefront having a residual aberration of the reflector antenna device.

FIG. 12 is a view for describing a relationship between a wavefront of a radio wave of a low frequency f_{L} and a wavefront having the residual aberration in the reflector antenna device according to Embodiment 1.

FIG. 13 is a view illustrating a simulation result of a gain with respect to a frequency.

FIG. 14 is a perspective view illustrating a simulation model of a horn antenna that is the primary radiator in the reflector antenna device according to Embodiment 1.

FIG. 15 is a view illustrating a simulation result of a phase center with respect to a frequency.

FIG. 16 is a view illustrating a simulation result of a gain decrease due to a phase error with respect to a frequency.

FIG. 17 is a view illustrating a second simulation result of the phase center with respect to a frequency.

FIG. 18 is a view illustrating a simulation result of a gain with respect to a frequency.

FIG. 19 is a view illustrating a simulation result of efficiency with respect to a frequency.

FIG. 20 is a view illustrating a second simulation result of a gain decrease due to a phase error with respect to a frequency.

### DESCRIPTION OF EMBODIMENTS

### Embodiment 1

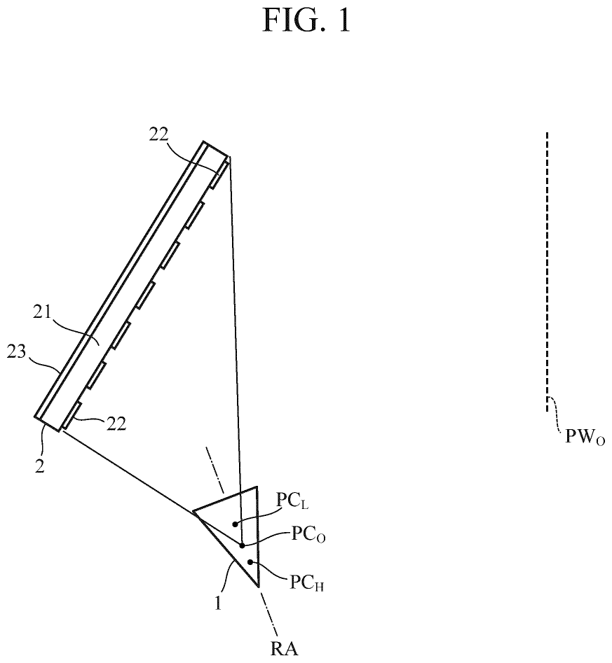

A reflector antenna device according to Embodiment 1 will be described with reference to FIGS. 1 to 20.

The reflector antenna device includes a primary radiator 1 and a reflector 2.

As for the primary radiator 1, the primary radiator 1 and the reflector 2 are disposed to have such a positional relationship that an angle formed by a line segment that connects a position of a virtual image with respect to a position PC₀ of a phase center at which the primary radiator 1 radiates a set frequency f₀ and a center point 2(O) of the reflector 2, and a horizontal plane that passes the center point 2(O) of the reflector 2, that is, a so-called horn angle is θ.

The primary radiator 1 includes a built-in radio wave path length adjustor that adjusts a path length from a position PC of a phase center in the primary radiator 1 to the center point 2(O) on a reflection surface of the reflector 2 depending on a frequency f of a radio wave radiated from the primary radiator 1.

That is, for a plurality of radio waves of set different frequency bands that are wide bands ranging from a low frequency f_{L} to a high frequency f_{H}, the primary radiator 1 adjusts the position PC of the phase center of the radio wave to be radiated, forward and backward along a radial axis RA of the radio wave depending on the frequency f of the radio wave to be radiated, and radiates the radio wave.

The primary radiator 1 positions a position PC_{H} of a phase center of a radio wave of the high frequency f_{H} backward along the radial axis RA of the radio wave with respect to a position PC_{L} of a phase center of a radio wave of the low frequency f_{L} as illustrated in FIG. 1.

In other words, for the radio waves within the frequency bands ranging from the low frequency f_{L} to the high frequency f_{H}, the primary radiator 1 continuously adjusts the position PC of the phase center from the position PC_{L} of the phase center to the position PC_{H} of the phase center depending on the frequency f.

The low frequency f_{L} indicates a frequency at a lower end of the frequency band set to the radio wave radiated from the primary radiator 1, and the high frequency f_{H} indicates a frequency at an upper end of the frequency band set to the radio wave radiated from the primary radiator 1.

The primary radiator 1 radiates radio waves of horizontal and vertical polarizations. The primary radiator 1 may be a horn antenna, or may be antennas other than the horn antenna.

Hereinafter, an example where the primary radiator 1 is the horn antenna will be described.

Before the primary radiator 1 will be specifically described, the reflector 2 will be described.

The reflector 2 includes a dielectric plate 21, a plurality of resonance elements 22 that are aligned on the top surface of the dielectric plate 21 that is a reflection surface for reflecting a radio wave, and a metal plate 23 that is provided on the back surface of the dielectric plate 21.

The reflector 2 is a so-called reflect array that uses a reflector plate of a flat plate shape.

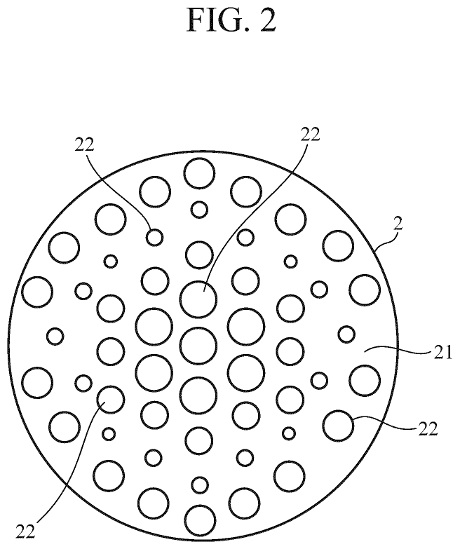

The dielectric plate 21 has a flat plate shape as illustrated in FIG. 2.

Each resonance element 22 adjusts the phase of a reflected wave of an incident radio wave (hereinafter, referred to as a reflection phase).

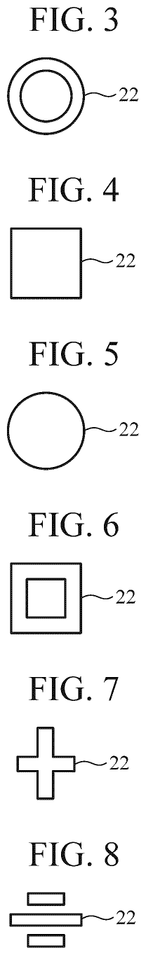

Each resonance element 22 has a circular ring shape as illustrated in FIG. 3, that is, a ring shape that has a size matching the position on the top surface of the dielectric plate 21, that is, the diameter matching the position on the top surface of the dielectric plate 21.

Note that each resonance element 22 may be a random shape such as a rectangular patch type as illustrated in FIG. 4, a circular patch type as illustrated in FIG. 5, a rectangular ring type as illustrated in FIG. 6, a cross type as illustrated in FIG. 7, and a rectangular patch type including a plurality of bars as illustrated in FIG. 8, or may have a shape formed by combining a plurality of shapes.

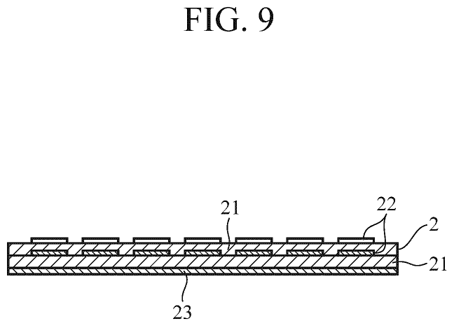

Furthermore, the plurality of resonance elements 22 are not limited to the resonance elements arranged in one layer of the same plane on the top surface of the dielectric plate 21, and the plurality of resonance elements 22 may be disposed separately in two layers on the top surface of the dielectric plate 21 as illustrated in FIG. 9 or may be disposed in three or more layers.

The reflection phase of the reflector 2 is determined on the basis of the shape and the size of each resonance element 22, an interval between the plurality of resonance elements 22, and the relative permittivity and the thickness of the dielectric plate 21.

The reflection phase of the reflector 2 depends on a path length that matches the position on the top surface of the dielectric plate 21, and that travels from the position PC of the phase center of the primary radiator 1 to the reflection surface that is the top surface of the dielectric plate 21.

Consequently, the reflector 2 can control a value of the reflection phase by disposing the resonance elements 22 that have the different shapes and sizes on the top surface of the dielectric plate 21 depending on the position on the top surface of the dielectric plate 21, and determines the shapes and the sizes of the resonance elements 22 and reflect so as to convert a spherical wave into a planar wave PW on an aperture of the reflector 2 in such a way as to obtain a spherical wave incident on the top surface of the reflector 2 as the planar wave PW on the aperture of the reflector 2.

In Embodiment 1, the shape and the size of each of the plurality of resonance elements 22 of the reflector 2 are determined matching the position on the top surface of the dielectric plate 21, and each of the plurality of resonance elements 22 is disposed on the top surface of the dielectric plate 21 in such a way that the primary radiator 1 obtains as a planar wave PW₀ on the aperture the spherical wave that is obtained from the radio wave of the set frequency f₀ radiated from the position PC₀ of the phase center and is incident on the reflector 2.

The set frequency f₀ is preferably a middle frequency f_{M} that takes a middle value of the high frequency f_{H} and the low frequency f_{L} radiated from the primary radiator 1, yet may be a frequency that takes a value between the high frequency f_{H} and the low frequency f_{L}.

The primary radiator 1 determines the position PC of the phase center of the radio wave of the frequency f within the frequency band ranging from the radio wave of the low frequency f_{L} to the radio wave of the high frequency f_{H} sing the position PC₀ of the phase center of the radio wave of the set frequency f₀ as the reference.

That is, the primary radiator 1 determines the position PC of the phase center of the radio wave of the frequency f in the frequency band by adding or subtracting a shift amount Δ expressed by the following equation (1) using the position PC₀ of the phase center of the radio wave of the set frequency f₀ as the reference.

In other words, for the radio wave of the frequency f within the frequency band ranging from the radio wave of the low frequency f_{L} to the radio wave of the high frequency f_{H}, the primary radiator 1 continuously offsets the position PC of the phase center from the position PC_{L} of the phase center of the radio wave of the low frequency f_{L} to the position PC_{H} of the phase center of the radio wave of the high frequency f_{H} along a direction of the radial axis RA of the radio wave from the primary radiator 1.

$$Δ = ( ( {{λ}_{0}}_{{-}^{}} λ ) / {λ}_{0} ) \times ( {R}_{0} / {cos}^{3} θ ) \qquad ( 1 )$$

In the equation (1), λ₀ represents the wavelength of the radio wave of the set frequency f₀, λ represents the wavelength of the radio wave of the frequency f radiated from the primary radiator 1, R₀ represents a distance from the position PC₀ of the phase center of the radio wave of the set frequency f₀ radiated from the primary radiator 1 to the aperture center of the reflector 2 via the center point 2(O) of the reflector 2, and θ represents an image horn angle.

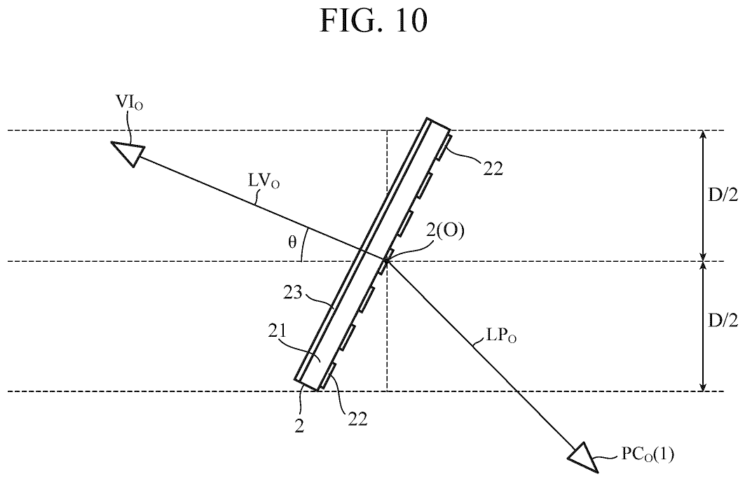

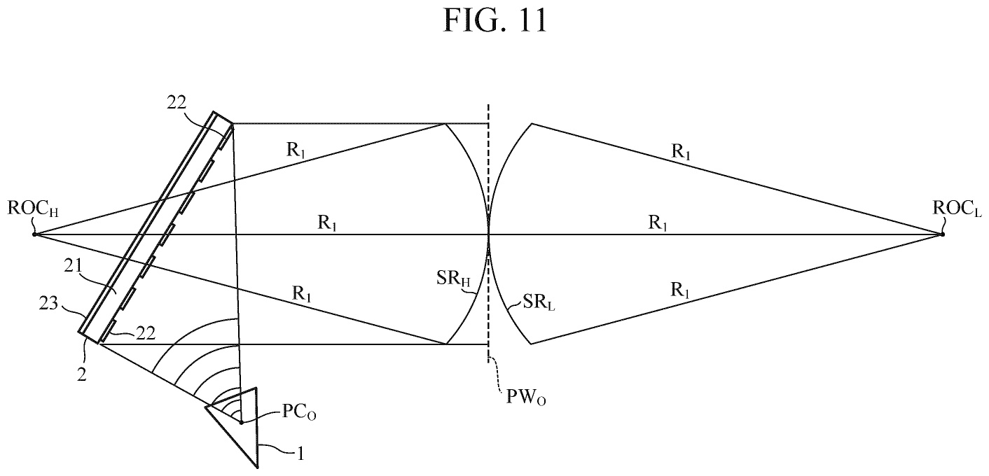

As illustrated in FIG. 10, the image horn angle θ is an angle formed by a line segment LV₀ that connects a position VI₀ of a virtual image with respect to the position PC₀ of the phase center of the primary radiator 1 and the center point 2(O) of the reflector 2, and a horizontal plane that passes the center point 2(O) of the reflector 2.

At this time, the position VI₀ of the virtual image with respect to the position PC₀ of the phase center of the primary radiator 1 is a position of a virtual image with respect to the position PC₀ of the phase center set to the radio wave of the set frequency f₀ radiated from the primary radiator 1.

Furthermore, a line segment LP₀ that connects the center point 2(O) of the reflector 2, that is, the position of the center on the top surface of the dielectric plate 21 and the position PC₀ of the phase center of the primary radiator 1, and the line segment LV₀ that connects the center point 2(O) of the reflector 2 and the position VI₀ of the virtual image with respect to the position PC₀ of the phase center of the primary radiator 1 have the same length L₀.

Note that, in FIG. 10, the diameter of the aperture of the reflector 2 is denoted as D.

Furthermore, although the thickness of each resonance element 22 is very thin, the thickness is schematically illustrated larger in FIG. 10. Furthermore, although the center point 2(O) of the reflector 2 is illustrated as if the center point 2(O) is on the top surface of the resonance element 22 at the position of the center on the top surface of the dielectric plate 21, the center point 2(O) of the reflector 2 is the position of the center on the planar surface of the dielectric plate 21.

The primary radiator 1 radiates the radio wave of the frequency f toward the reflector 2 from the position PC of the phase center matching the frequency f of the radio wave to be radiated using the above equation (1). As a result, it is possible to obtain even the radio wave of the frequency f other than the set frequency f₀ as the planar wave PW on the aperture of the reflector 2, and reduce a gain decrease due to a residual aberration.

A reason that the gain decrease due to the residual aberration can be reduced at the frequency f even other than the set frequency f₀ will be described below.

First, the residual aberration will be described with reference to FIG. 11.

Here, the reflector 2 is set in such a way that, when the primary radiator 1 radiates the radio wave of the set frequency f₀ toward the reflector 2 using the position PC₀ of the phase center as the reference, the radio wave is reflected by the reflection surface of the reflector 2, and is obtained as the planar wave PW₀ on the aperture of the reflector 2.

Even if an ideal reflector 2 in which the reflection phase of each resonance element 22 does not have frequency dependency is used, radiation of the radio wave of the frequency f other than the set frequency f₀ from the primary radiator 1 from the position PC₀ of the phase center causes a residual aberration caused by a gain decrease of the radio wave of the frequency f and having a phase error of a spherical wave SR of a curvature radius R₁ from a position ROC of the curvature center.

In a case where, for example, the frequency f of the radio wave radiated by the primary radiator 1 from the position PC₀ of the phase center is less than the set frequency f₀ (f<f₀), as illustrated in FIG. 11, the wavefront on the aperture of the reflector 2 can be approximated to a spherical wave SR_{L} whose position ROC_{L} of the curvature center is positioned on the right side of the reflector 2 in FIG. 11 and whose curvature radius is R₁.

Furthermore, in a case where the frequency f of the radio wave radiated by the primary radiator 1 from the position PC₀ of the phase center exceeds the set frequency f₀ (f>f₀), as illustrated in FIG. 11, the wavefront on the aperture of the reflector 2 can be approximated to a spherical wave SR_{H} whose position ROC_{H} of the curvature center is positioned on the left side of the reflector 2 in FIG. 11 and whose curvature radius is R₁.

That is, in the case where the frequency f of the radio wave radiated by the primary radiator 1 from the position PC₀ of the phase center is other than the set frequency f₀, the wavefront on the aperture of the reflector 2 can be regarded as the spherical wave SR of the curvature radius R₁ radiated from the position ROC of the curvature center.

The wavefront can be regarded as the spherical wave SR of the curvature radius R₁, and therefore a residual aberration having a phase error based on the spherical wave SR of the curvature radius R₁ occurs.

In other words, in a case where the radio wave radiated by the primary radiator 1 from the position PC₀ of the phase center is a radio wave of a frequency other than the set frequency f₀, the wavefront on the aperture of the reflector 2 is not converted into the planar wave PW₀ by the reflector 2, and becomes a wavefront that can be approximated to the spherical wave SR of the curvature radius R₁.

As a result, the residual aberration based on the spherical wave SR of the curvature radius R₁ occurs.

In other words, the residual aberration can be expressed by the spherical wave SR of the curvature radius R₁.

The curvature radius R₁ of the spherical wave SR can be expressed by the following equation (2).

$${R}_{1} = ( {R}_{0} / α ) {cos}^{3} θ \qquad ( 2 )$$

$$α = ( {λ}_{0} - λ ) / {λ}_{0} \qquad ( 3 )$$

In the equation (2) and the equation (3), λ₀ represents the wavelength of the radio wave of the set frequency f₀, λ represents the wavelength of the radio wave of the frequency f radiated from the primary radiator 1, and θ represents an image horn angle.

The curvature radius R₁ of the spherical wave SR is determined on the basis of two parameters of a distance R from the position PC₀ of the phase center of the radio wave of the set frequency f₀ radiated from the primary radiator 1 to the aperture center of the reflector 2 via the center point 2(O) of the reflector 2, and the image horn angle θ.

Note that it is defined as illustrated in FIG. 11 that, when the curvature radius R₁ expressed by the above equation (2) is negative (R₁<0), the position ROC_{L} of the curvature center of the spherical wave SR_{L} of the curvature radius R₁ is located on the right side of the reflector 2, and, when the curvature radius R₁ is positive (R₁>0), the position ROC_{H} of the curvature center of the spherical wave SR_{H} of the curvature radius R₁ is located on the left side of the reflector 2.

The radius is infinite ∞ when the frequency of the radio wave is the set frequency f₀, and the radio wave obtained when the radio wave of the set frequency f₀ radiated from the primary radiator 1 is reflected by the reflector 2 is converted into the planar wave PW₀ on the aperture of the reflector 2.

When the radio wave of the frequency f other than the set frequency f₀ radiated from the primary radiator 1 is radiated from the position PC₀ of the phase center, α in the above equation (2) takes a finite value, the wavefront on the aperture of the reflector 2 becomes the spherical wave SR of the curvature radius R₁, and a residual aberration occurs.

However, according to the reflector antenna device according to Embodiment 1,the primary radiator 1 determines the position of the phase center PC of the primary radiator 1 depending on the frequency f of the radio wave radiated from the primary radiator 1 by adding or subtracting the shift amount Δ expressed in the above equation (1) using the position PC₀ of the phase center of the radio wave of the set frequency f₀ as the reference, so that it is possible to cancel the residual aberration for the radio wave of the frequency f other than the set frequency f₀, and reduce a gain decrease.

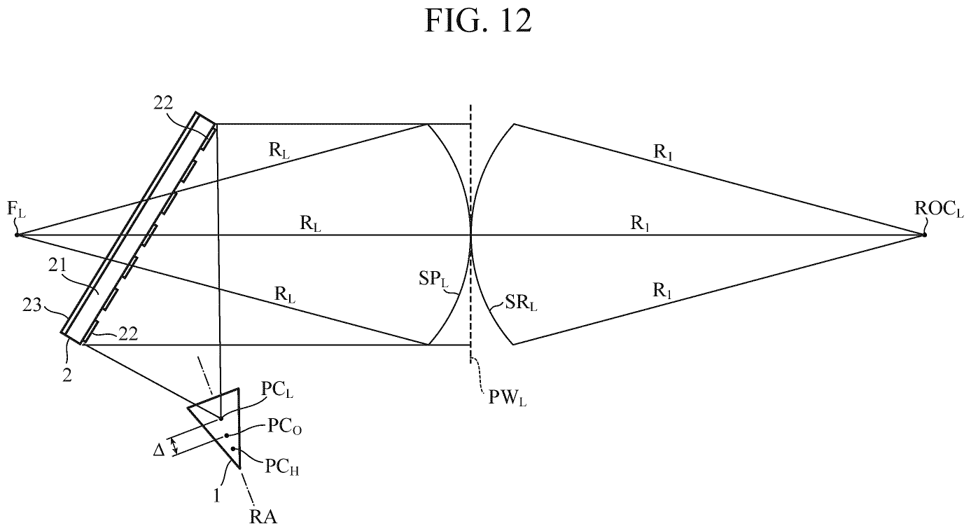

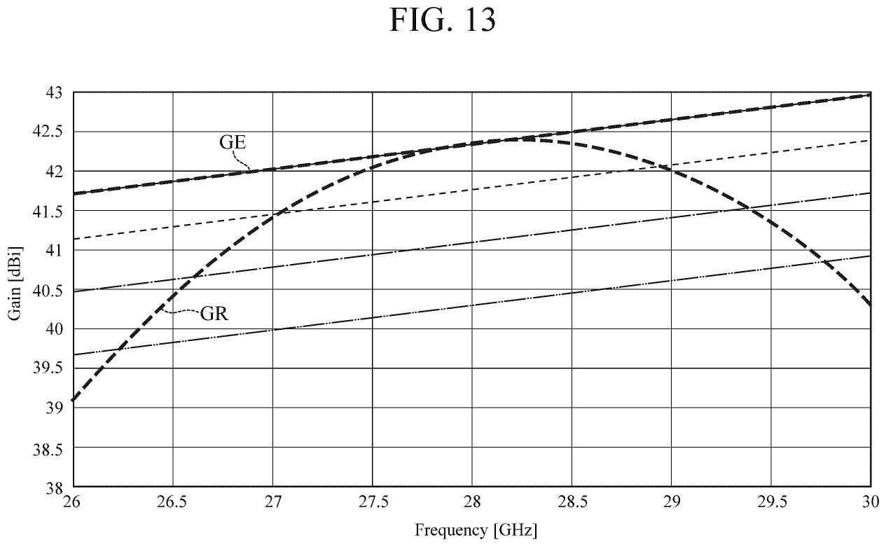

FIG. 12 illustrates, for example, a wavefront (spherical wave SP_{L}) of the radio wave of the low frequency f_{L} at a time when the primary radiator 1 radiates the radio wave of the low frequency f_{L} (f_{L}<f₀) from the position PC_{L} of the phase center toward the reflector 2, and a wavefront (spherical wave SR_{L}) at a time when the primary radiator 1 radiates the radio wave of the low frequency f_{L} from the position PC₀ of the phase center toward the reflector 2.

The position PC_{L} of the phase center is a position obtained by offsetting the shift amount Δ calculated on the basis of the above equation (1) for the frequency f_{L} forward from the position PC₀ of the phase center along the direction of the radial axis RA of the primary radiator 1 using the position PC₀ of the phase center as the reference.

When the primary radiator 1 radiates the radio wave of the low frequency f_{L} from the position PC_{L} of the phase center toward the reflector 2, the position PC_{L} of the phase center at which the low frequency f_{L} is radiated is moved by the shift amount Δ from the position PC₀ of the phase center as illustrated in FIG. 12, and therefore the spherical wave SP_{L} of the curvature radius R_{L} radiated from a position F_{L} of the curvature center is produced.

Furthermore, the spherical wave SR_{L} of the curvature radius R₁ at a time when the radio wave of the low frequency f_{L} that causes a residual aberration is radiated from the position PC₀ of the phase center toward the reflector 2 is also produced.

As a result, the spherical wave SP_{L} at the time when the primary radiator 1 radiates the radio wave of the low frequency f_{L} from the position PC_{L} of the phase center toward the reflector 2, and the spherical wave SR_{L} that causes the residual aberration correct each other, so that a planar wave PW_{L} is obtained on the aperture of the reflector 2.

Thus, a reason that, by setting the position PC of the phase center of the primary radiator 1 at which the frequency f is radiated, to a position obtained by offsetting the shift amount Δ calculated on the basis of the above equation (1) from the position PC₀ of the phase center, the spherical wave SP at the time when the radio wave of the frequency f is radiated from the position PC of the phase center toward the reflector 2, and the spherical wave SR that causes the residual aberration correct each other, and the planar wave PW can be obtained is as follows.

That is, when the position PC of the phase center of the primary radiator 1 is moved by the shift amount Δ from the position PC₀ of the phase center along the direction of the radial axis RA of the primary radiator 1, the reflector 2 approximates to a lens of a focal distance F, and the following equation (4) holds.

$$( 1 / {R}_{0} ) - ( 1 / ∞ ) = ( 1 / ( {R}_{0} + Δ ) ) - ( 1 / {R}_{2} ) = 1 / F \qquad ( 4 )$$

In the equation (4), R₂ represents a curvature radius of the spherical wave SP that becomes the wavefront on the aperture of the reflector 2 at the time when the phase center PC moves. The curvature radius R_{L} of the spherical wave SP_{L} illustrated in FIG. 12 and obtained at the time when the radio wave of the low frequency f_{L} is radiated from the position PC_{L} of the phase center toward the reflector 2 corresponds to a value of R₂ in the above equation (4).

A curvature radius R₂ can be expressed by the following equation (5) on the basis of the above equation (4).

$${R}_{2} = - ( {{R}_{0}}^{2} / Δ ) \qquad ( 5 )$$

A condition that the spherical wave SR of the curvature radius R₁ that causes the residual aberration by the radio wave of the frequency f, and the spherical wave SP of the curvature radius R₂ produced by moving the position PC of the phase center by the shift amount Δ from the position PC₀ of the phase center cancel each other to obtain the radio wave of the frequency f other than the set frequency f₀ as the planar wave PW on the aperture of the reflector 2 is the following equation (6).

$${R}_{1} + {R}_{2} = 0 \qquad ( 6 )$$

By substituting the above equation (2) and the above equation (5) in the above equation (6), it is possible to obtain the shift amount Δ in the above equation (1).

That is, by calculating the shift amount Δ using the above equation (1) for the frequency f, moving the position PC of the phase center of the primary radiator 1 by the shift amount Δ from the position PC₀ of the phase center to a position PC₀+Δ, and radiating the radio wave of the frequency f from the primary radiator 1, it is possible to obtain the planar wave PW on the aperture of the reflector 2.

Next, an operation of the reflector antenna device according to Embodiment 1 will be described.

First, when the frequency f of the radio wave radiated from the primary radiator 1 is set, the primary radiator 1 calculates and determines the position PC of the phase center at the frequency f on the basis of the above equation (1).

The primary radiator 1 radiates the radio wave of the frequency f toward the reflector 2 from the determined position PC of the phase center at the frequency f.

When the frequency f of the radio wave to be radiated is the set frequency f₀, the reflection phase is adjusted by the plurality of resonance elements 22 of the reflector 2, and the reflector 2 reflects the radio wave of the set frequency f₀ radiated from the primary radiator 1 by converting the spherical wave of the radio wave of the set frequency f₀ into the planar wave PW₀ on the aperture of the reflection surface of the reflector 2.

Furthermore, when the frequency f of the radio wave to be radiated is a frequency other than the set frequency f₀, the spherical wave SR of the curvature radius R₁ that causes the residual aberration by the radio wave of the frequency f, and the spherical wave SP of the curvature radius R₂ produced by moving the position PC of the phase center by the shift amount Δ from the position PC₀ of the phase center cancel each other, and the reflector 2 reflects the incident radio wave of the frequency f radiated from the primary radiator 1 in such a way that the radio wave of the frequency f becomes the planar wave PW on the aperture of the reflector 2.

Gain frequency characteristics of a gain with respect to the frequency f of the radio wave radiated from the primary radiator 1 was simulated for the reflector antenna device according to Embodiment 1.

This simulation was conducted to test that the radio wave became the planar wave PW on the aperture of the reflector 2, that is, the residual aberration was cancelled or reduced, and that therefore the residual aberration did not occur at the lower end frequency f_{L} to the upper end frequency f_{H}, and a gain decrease did not occur.

Hence, the gain decrease due to the residual aberration are taken into account for the gain frequency characteristics, and simulation was conducted under a condition that the reflection phase of each resonance element 22 did not have frequency dependency, that is, loss caused by a phase error resulting from the frequency characteristics of each resonance element 22 did not occur.

Furthermore, the above condition means that there is no loss such as spillover loss, reflection loss, and loss due to an amplitude distribution.

Furthermore, simulation setting conditions are that the setting frequency f₀ is 28 GHz, an aperture diameter D is 500 mm, a distance Ro from the position PC₀ of the phase center of the radio wave of the set frequency f₀ radiated from the primary radiator 1 to the aperture center of the reflector 2 via the center point 2(O) of the reflector 2 is 450 mm, the image horn angle θ is 0 deg, the frequency f_{L} at the lower end of the frequency band set to the radio wave radiated from the primary radiator 1 is 26 GHz, and the frequency f_{H} at the upper end of the frequency band is 30 GHz.

The shift amount Δ at the time when the primary radiator 1 continuously changed the frequency f within the frequency band from the lower end frequency f_{L} to the upper end frequency f_{H} was calculated on the basis of the above equation (1) under the above conditions, and when the primary radiator 1 radiated the radio wave of the frequency f from the lower end frequency f_{L} to the upper end frequency f_{H} associated with the position PC of the phase center, from the position PC of the phase center offset from the position PC₀ of the phase center by the shift amount Δ depending on the frequency f of the radio wave to be radiated, and gain frequency characteristics indicated by a solid line GE in FIG. 13 could be obtained.

Furthermore, when the primary radiator 1 radiated the radio wave of the frequency f from the lower end frequency f_{L} to the upper end frequency f_{H} without moving a position of the phase center from the position PC₀ of the phase center in a reference example, gain frequency characteristics indicated by a broken line GR in FIG. 13 could be obtained.

As is understandable from the solid line GE illustrated in FIG. 13, the reflector antenna device according to Embodiment 1 could obtain as the planar wave PW on the aperture of the reflector 2 not only the radio wave of the set frequency f₀, but also the radio wave from the lower end frequency f_{L} to the upper end frequency f_{H}, and a gain decrease did not occur.

As a result, constant aperture efficiency is obtained for the radio wave from the lower end frequency f_{L} to the upper end frequency f_{H}.

By contrast with this, as is understandable from the broken line GR illustrated in FIG. 13, while the same result as that of the reflector antenna device according to Embodiment 1 was obtained for the radio wave of the set frequency f₀ in the reference example, as the frequency becomes more distant from the set frequency f₀, that is, the frequency becomes closer to the lower end frequency f_{L} and the upper end frequency f_{H}, a residual aberration occurs, and a gain decrease occurs.

As a result, as the frequency becomes closer to the lower end frequency f_{L} and the upper end frequency f_{H}, the aperture efficiency lowers.

The above test result shows that, compared to the reference example, the reflector antenna device according to Embodiment 1 can obtain the radio wave from the lower end frequency f_{L} to the upper end frequency f_{H} as the planar wave PW on the aperture of the reflector 2, does not cause a gain decrease, and, consequently, has the constant aperture efficiency for the radio wave from the lower end frequency f_{L} to the upper end frequency f_{H}.

As described above, the primary radiator 1 adjusts the position PC of the phase center of the radio wave forward and backward along the radial axis RA of the radio wave depending on the frequency f of the radio wave to be radiated, and radiates the radio wave, and therefore the spherical wave SR of the curvature radius R₁ that causes a residual aberration by the radio wave of the frequency f, and the spherical wave SP of the curvature radius R₂ produced by adjusting the position PC of the phase center forward and backward and moving the position PC cancel each other for the radio wave from the lower end frequency f_{L} to the upper end frequency f_{H} other than the radio wave of the set frequency f₀, so that the reflector antenna device according to Embodiment 1 can obtain the planar wave PW on the aperture of the reflector 2, and reduce a gain decrease.

As a result, it is possible to provide a wider band of the frequency of the radio wave radiated from the primary radiator 1.

Particularly, the reflector antenna device according to Embodiment 1 determines adjustment of the position PC of the phase center of the radio wave radiated by the primary radiator 1 by the shift amount A calculated on the basis of the above equation (1) for the frequency f within the frequency band ranging from the low frequency f_{L} to the high frequency f_{H} using the position PC₀ of the phase center of the radio wave of the set frequency f₀ as the reference, and the spherical wave SR of the curvature radius R₁ that causes the aberration residual by the radio wave of the frequency f, and the spherical wave SP of the curvature radius R₂ that is produced by moving the position PC of the phase center by the shift amount Δ from the position PC₀ of the phase center cancel each other for the radio wave from the lower end frequency f_{L} to the upper end frequency f_{H} other than the radio wave of the set frequency f₀, so that it is possible to obtain the planar wave PW on the aperture of the reflector 2, and a gain decrease does not occur.

As a result, it is possible to provide a wider band of the frequency of the radio wave radiated from the primary radiator 1.

Note that, although the reflector antenna device according to above Embodiment 1 determines the position PC of the phase center of the radio wave radiated by the primary radiator 1 by the shift amount Δ calculated on the basis of the above equation (1) for the frequency f within the frequency band ranging from the low frequency f_{L} to the high frequency f_{H} using the position PC₀ of the phase center of the radio wave of the set frequency f₀ as the reference, and continuously offsets the position PC along the direction of the radial axis RA of the primary radiator 1, the reflector antenna device may determine the shift amount Δ stepwise for a plurality of different frequencies, and offset the position PC stepwise along the direction of the radial axis RA of the primary radiator 1 using the position PC₀ of the phase center as the reference.

For example, a shift amount Δ_{L} for the radio wave of the low frequency f_{L} is calculated on the basis of the following equation (7), and a shift amount Δ_{H} for the radio wave of the high frequency f_{H} is calculated on the basis of the following equation (8).

$${Δ}_{L} = ( ( {λ}_{0} - {λ}_{L} ) / {λ}_{0} ) \times ( {R}_{0} / {cos}^{3} θ ) \qquad ( 7 )$$

$${Δ}_{H} = ( ( {λ}_{0} - {λ}_{H} ) / {λ}_{0} ) \times ( {R}_{0} / {cos}^{3} θ ) \qquad ( 8 )$$

In the equation (7) and the equation (8), λ_{L} represents the wavelength of the radio wave of the low frequency f_{L} radiated from the primary radiator 1, and λ_{H} represents the wavelength of the radio wave of the high frequency f_{H} radiated from the primary radiator 1.

When the radio wave radiated from the primary radiator 1 is the radio wave of the low frequency f_{L}, the primary radiator 1 calculates and determines the position PC_{L} of the phase center at the low frequency f_{L} on the basis of the above equation (7).

The primary radiator 1 radiates the radio wave of the low frequency f_{H} from the determined position PC_{L} of the phase center toward the reflector 2.

Furthermore, when the radio wave radiated from the primary radiator 1 is the radio wave of the high frequency f_{H}, the primary radiator 1 calculates and determines the position PC_{H} of the phase center at the high frequency f_{H} on the basis of the above equation (8).

The primary radiator 1 radiates the radio wave of the high frequency f_{H} from the determined position PC_{H} of the phase center toward the reflector 2.

Although the two frequencies of the low frequency f_{L} and the high frequency f_{H} have been exemplified above and described, the shift amounts Δ for a plurality of different frequencies may be determined on the basis of the above equation (1) for the plurality of different frequencies in the frequency band of the low frequency f_{L} to the high frequency f_{H}, the primary radiator 1 may radiate each of the radio waves of the plurality of different frequencies from the position PC of the phase center determined for each of the radio waves of the plurality of different frequencies.

The results of the gain frequency characteristics illustrated in FIG. 13 were obtained by taking the gain decrease due to the residual aberration into account, and simulation was conducted under an ideal condition that there is no loss such as loss caused by a phase error resulting from the frequency characteristics of each resonance element 22, spillover loss, reflection loss, and loss due to an amplitude distribution. Hence, also as the horn antenna, an ideal device having no specific shape is used.

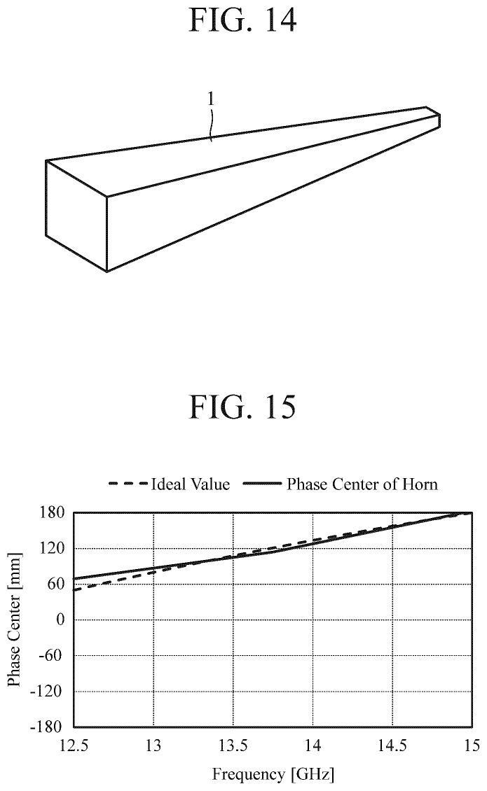

Hence, the effect of the reflector antenna device according to Embodiment 1 was tested using a horn antenna illustrated in FIG. 14 that employed a more realistic configuration as the primary radiator 1.

The horn antenna illustrated in FIG. 14 is a horn antenna whose aperture shape is rectangular, an aperture size is 98.5 mm×75.6 mm, and an axial length is 400 mm.

Furthermore, simulation setting conditions (I) are that the setting frequency f₀ is 13.75 GHz, the aperture diameter D was 330 mm, the distance R₀ from the position PC₀ of the phase center of the radio wave of the set frequency f₀ radiated from the primary radiator 1 to the aperture center of the reflector 2 via the center point 2(O) of the reflector 2 is 680 mm, the image horn angle θ is 0 deg, the frequency f_{L} at the lower end of the frequency band set to the radio wave radiated from the primary radiator 1 is 12.5 GHz, and the frequency f_{H} at the upper end of the frequency band is 15 GHz.

Note that this simulation (I) performed calculation taking loss due to an amplitude distribution and spillover loss into account.

FIG. 15 illustrates a result obtained by comparing frequency characteristics of the phase center of the horn antenna illustrated in FIG. 14, and frequency characteristics of an ideal phase center satisfying the above equation (1) under the above simulation setting conditions.

In FIG. 15, the solid line indicates the frequency characteristics of the phase center of the horn antenna illustrated in FIG. 14, and the broken line indicates the frequency characteristics of the ideal phase center satisfying the above equation (1).

As is clear from FIG. 15, the reflector antenna device according to Embodiment 1 that uses the horn antenna illustrated in FIG. 14 can obtain an ideal phase center position at 12.5 GHz to 15 GHz in frequency.

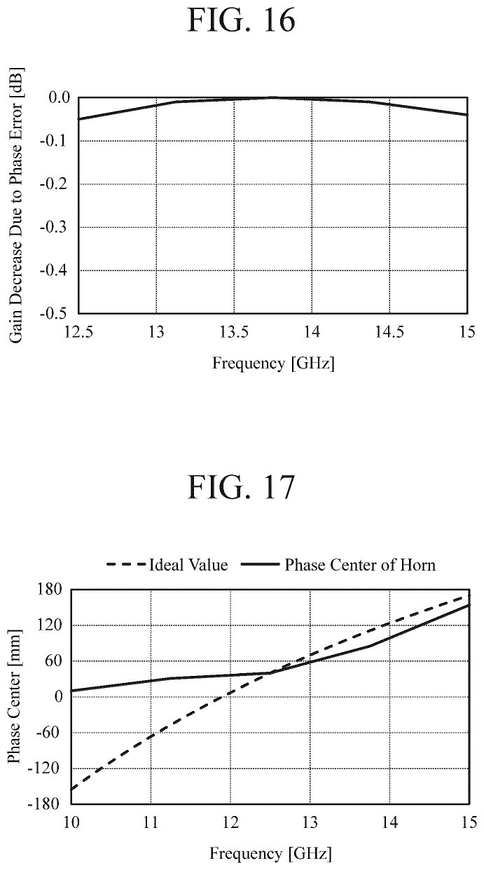

FIG. 16 illustrates a result obtained by calculating loss due to a phase error with respect to the frequency, that is, a gain decrease under the above simulation (I) setting conditions.

As is clear from FIG. 16, it is possible to find that, at 12.5 GHz to 15 GHz in frequency, loss due to the phase error is 0.1 dB or less, and loss is sufficiently little.

That is, the reflector antenna device according to Embodiment 1 that uses the horn antenna illustrated in FIG. 14 can satisfy the above equation (1), and reduce loss due to a phase error that is a factor to limit the band of the reflect array.

A test result illustrated in FIG. 16 indicates a result obtained by performing study under an ideal condition that the phase center of the horn antenna illustrated in FIG. 14 satisfies the above equation (1).

However, the horn antenna is not limited to the horn antenna whose phase center satisfies the above equation (1), and it is possible to provide the effect only by placing the phase center of the horn antenna close to the above equation (1).

This point will be tested by following simulation.

Simulation setting conditions (II) are that the setting frequency f₀ is 12.5 GHz, the aperture diameter D is 500 mm, the distance R₀ from the position PC₀ of the phase center of the radio wave of the set frequency f₀ radiated from the primary radiator 1 to the aperture center of the reflector 2 via the center point 2(O) of the reflector 2 is 845 mm, the image horn angle θ is 0 deg, the frequency f_{L} at the lower end of the frequency band set to the radio wave radiated from the primary radiator 1 is 10 GHz, and the frequency f_{H} at the upper end of the frequency band is 15 GHz.

FIG. 17 illustrates a result obtained by comparing frequency characteristics of the phase center of the horn antenna illustrated in FIG. 14, and frequency characteristics of an ideal phase center satisfying the above equation (1) under the above simulation setting conditions (II).

In FIG. 17, the solid line indicates the frequency characteristics of the phase center of the horn antenna illustrated in FIG. 14, and the broken line indicates the frequency characteristics of the ideal phase center satisfying the above equation (1).

As is clear from FIG. 17, although the reflector antenna device according to Embodiment 1 that uses the horn antenna illustrated in FIG. 14 does not have an ideal phase center position at 10 GHz to 15 GHz in frequency, the phase center is close to an ideal value compared to the horn of the fixed phase center.

Similarly, under the above simulation setting conditions (II), the reflector antenna device according to Embodiment 1 that uses the horn antenna illustrated in FIG. 14, a reflector antenna device that uses a horn antenna having an ideal phase center satisfying the above equation (1), and a reflector antenna device that uses a horn antenna of a fixed phase center are compared as to a gain, efficiency, and loss due to a phase error with respect to a frequency.

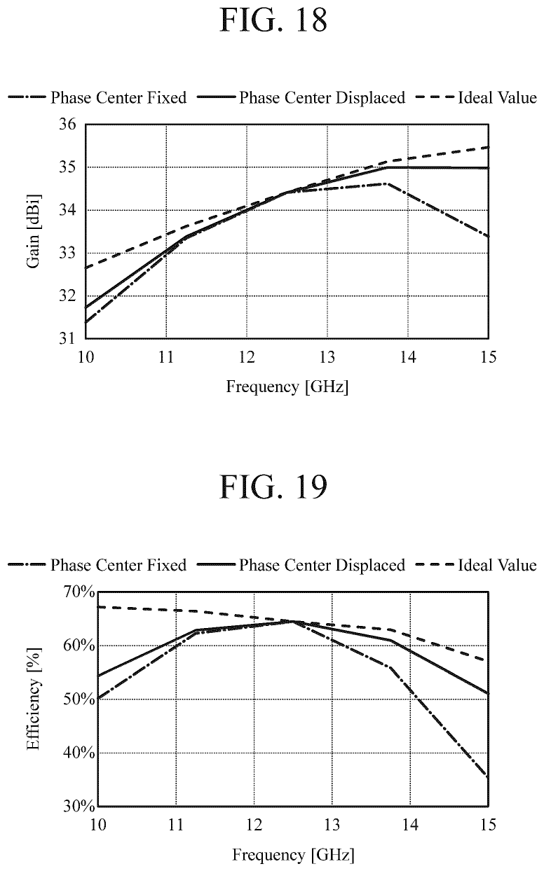

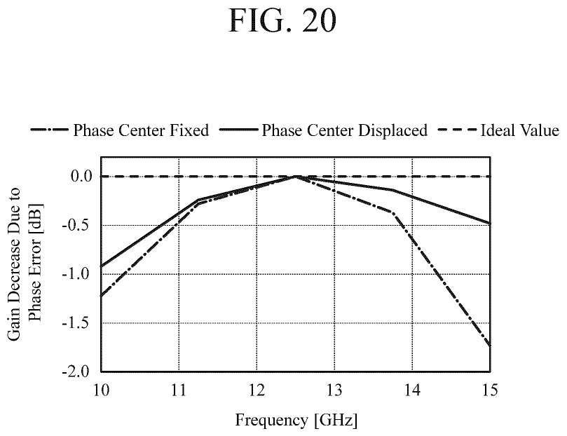

FIG. 18 illustrates a gain with respect to a frequency, FIG. 19 illustrates efficiency with respect to the frequency, and FIG. 20 illustrates loss due to a phase error with respect to the frequency.

In FIGS. 18 to 20, the solid line indicates characteristics of the reflector antenna device according to Embodiment 1 that uses the horn antenna illustrated in FIG. 14, the broken line indicates characteristics of the reflector antenna device that uses the horn antenna having the ideal phase center satisfying the above equation (1), and the dashed-dotted line indicates characteristics that use the reflector antenna device that uses the horn antenna of the fixed phase center.

As is clear from FIGS. 18 to 20, the reflector antenna device according to Embodiment 1 that uses the horn antenna illustrated in FIG. 14 reduces the loss due to the phase error with respect to the frequency, has improved frequency characteristics of the gain and the efficiency, and is close to the ideal compared to the reflector antenna device that uses the horn antenna of the fixed phase center.

Note that it is possible to freely combine each embodiment, modify any components of each embodiment, or omit any components in each embodiment.

### INDUSTRIAL APPLICABILITY

The reflector antenna device according to the present disclosure is suitable for a reflect array antenna that includes the primary radiator and the reflector of the flat plate shape.

### REFERENCE SIGNS LIST

1: primary radiator, 2: reflector, 21: dielectric plate, 22: resonance element, 23: metal plate, f_{L}, f_{M}, f_{H}, f₀: frequency, λ, λ_{L}, λ_{H}, λ₀: wavelength, PC_{L}, PC_{H}, PC₀: position of phase center, R₀: distance from position PC₀ of phase center of radio wave of set frequency f₀ radiated from primary radiator 1 to aperture center of reflector 2 via center point of reflector 2, θ: image horn angle

1. A reflector antenna device comprising:
a primary radiator to adjust a position of a phase center of a radio wave to be radiated, forward or backward along a radial axis of the radio wave depending on a frequency of the radio wave to be radiated, and radiate the radio wave; and
a reflector to receive the radio wave radiated from a phase center of the radio wave of a set frequency of the primary radiator and reflect the radio wave by converting a spherical wave of the radio wave into a planar wave on an aperture of the reflector, the reflector including a dielectric plate of a flat plate shape and a plurality of resonance elements that are aligned on a top surface of the dielectric plate that is a reflection surface for reflecting the radio wave, and that each adjust a phase of a reflected wave of the radio wave.

2. The reflector antenna device according to claim 1, wherein adjustment of the position of the phase center of the radio wave radiated by the primary radiator is determined as a position of a phase center at which a spherical wave of a curvature radius that causes a residual aberration by the radio of the frequency radiated by the primary radiator, and a spherical wave of a curvature radius that is produced by moving the position of the phase center forward or backward from a position of a phase center of a radio wave of a set frequency cancel each other.

3. The reflector antenna device according to claim 1, wherein adjustment of the position of the phase center of the radio wave radiated by the primary radiator is determined on a basis of a shift amount Δ calculated on a basis of a following equation (1) for a radio wave of a frequency f in a frequency band ranging from a low frequency to a high frequency using a position of a phase center of a radio wave of a set frequency f₀ as a reference
$$Δ = ( ( {{λ}_{0}}_{{-}^{}} λ ) {λ}_{0} ) \times ( {R}_{0} / {cos}^{3} θ ) \qquad ( 1 )$$
wherein, in the equation (1), λ₀ represents a wavelength of the radio wave of the set frequency f₀, λ0 represents a wavelength of the radio wave of the frequency f in the frequency band radiated from the primary radiator, R₀ represents a distance from the phase center of the radio wave of the set frequency f₀ radiated from the primary radiator to an aperture center of the reflector via a center point of the reflector, and θ represents an image horn angle.

4. The reflector antenna device according to claim 1, wherein
using a position of a phase center of a radio wave of a setting frequency f₀ as a reference, adjustment of the position of the phase center of the radio wave radiated by the primary radiator is determined on a basis of a first shift amount Δ_{L} calculated on a basis of a following equation (2) for a radio wave of a low frequency f_{L} compared to a set frequency f₀, and
is determined on a basis of a second shift amount Δ_{H} calculated on a basis of a following equation (3) for a radio wave of a high frequency f_{H} compared to the set frequency f₀,
$${Δ}_{L} = ( ( {λ}_{0} - {λ}_{L} ) / {λ}_{0} ) \times ( {R}_{0} / {cos}^{3} θ ) \qquad ( 2 )$$
$${Δ}_{H} = ( ( {{λ}_{0}}_{{-}^{}} {λ}_{H} ) / {λ}_{0} ) \times ( {R}_{0} / {cos}^{3} θ ) \qquad ( 3 )$$
wherein, in the equation (2) and the equation (3), λ₀ represents a wavelength of the radio wave of the set frequency f₀, λ_{L} represents a wavelength of the radio wave of the low frequency f_{L} radiated from the primary radiator, λ_{H} represents a wavelength of the radio wave of the high frequency f_{H} radiated from the primary radiator, R₀ represents a distance from the phase center of the radio wave of the set frequency f₀ radiated from the primary radiator to an aperture center of the reflector via a center point of the reflector, and θ represents an image horn angle.

5. The reflector antenna device according to claim 1, wherein the primary radiator radiates a radio wave of horizontal and vertical polarizations.

6. The reflector antenna device according to claim 1, wherein the primary radiator is a horn antenna.

7. The reflector antenna device according to claim 1, wherein each of the plurality of resonance elements has a circular ring shape.

8. The reflector antenna device according to claim 1, wherein each of the plurality of resonance elements has a circular shape.

9. The reflector antenna device according to claim 1, wherein each of the plurality of resonance elements has a rectangular ring shape.
